(19) United States
(12) Patent Application Publication
(10) Pub. No.: US 2013/0298651 A1
(43) Pub. Date: Nov. 14, 2013

(54) Ripe Fruit Indicator

(71) Applicant: Hugh Edward Johnson, Key West, FL (US)

(72) Inventor: Hugh Edward Johnson, Key West, FL (US)

(21) Appl. No.: 13/858,292

(22) Filed: Apr. 8, 2013

Related U.S. Application Data
(60) Provisional application No. 61/646,018, filed on May 11, 2012.

(51) Int. Cl. G01N 3/40

(52) U.S. Cl. CPC G01N 3/40
USPC 73/81

(57) ABSTRACT

This invention provides a measurable, easy and inexpensive way to gauge the ripeness/hardness of the interior of a fruit without cutting into it.

### CROSS REFERENCE TO RELATED APPLICATIONS

Provisional patent was submitted May 11, 2012

EFS ID: 12761729

Application No: 61/646,018

Confirmation number: 2081

Title: Ripe Fruit Gauge

Customer Number: 72899

### STATEMENT REGARDING FEDERALLY SPONSORED RESEARCH

Not applicable

### REFERENCE TO SEQUENCING LIST

Not applicable

### BACKGROUND OF THE INVENTION

It is often difficult to determine when some fruits such as cantaloupe, peaches, pears, mango, kiwi and avocado are ripe on the inside. The exterior may be hard while the inside is ideal for eating. Fruit may be cut open to determine ripeness, but if the fruit is not yet ripe, it tends to rot and not ripen further. Pushing with a finger is a common test for ripeness and may work if the timing is right, but creating a consistent measurable result without bruising the fruit is difficult.

This invention was designed to provide a consistent, measurable, easy and inexpensive way to gauge the ripeness/hardness of the interior of a fruit without cutting it open or bruising it.

### BRIEF SUMMMARY OF THE INVENTION

This invention helps gauge ripeness of fruit without cutting it open. If an unripe fruit is sliced open, its ability to ripen without rotting is diminished greatly.

A narrow spring loaded wire probe is immersed in the fruit and if it is not ripe, the hard fruit will resist the wire probe from penetrating into it, causing the spring to compress. When the operator releases the body of the invention, it will spring away from the fruit. By observing the degree of spring back, the user can determine the degree of ripeness. If the fruit is not ripe it may then continue to ripen and may be tested again at a later time.

### BRIEF DESCRIPTION OF SEVERAL VIEWS OF THE DRAWINGS

FIG. 1/3 is a drawing of the invention

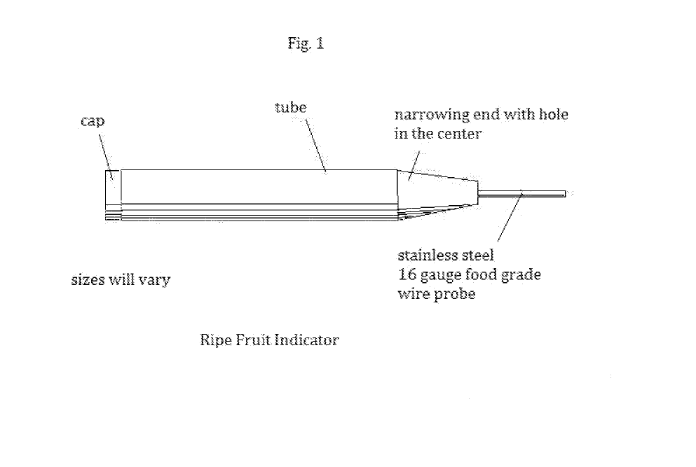

FIG. 2/3 is a cross section of the invention inserted into a ripe soft fruit

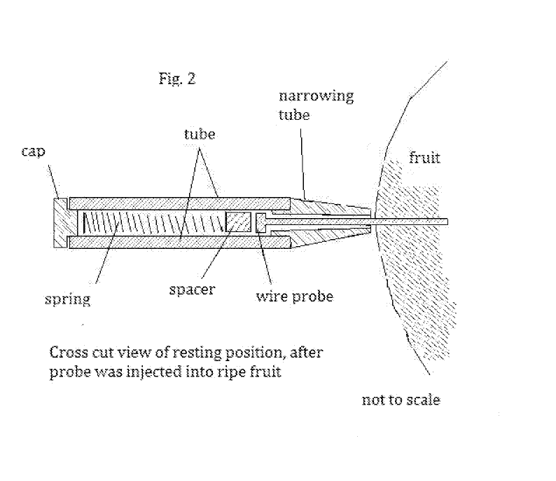

FIG. 3/3 is a cross section of the invention inserted into a hard unripe fruit

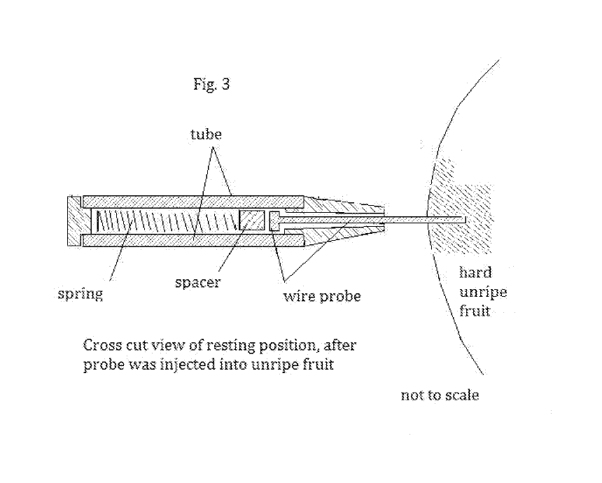

### DETAILED DESCRIPTION OF THE INVENTION

This invention gets below the hard surface of a cantaloupe or other fruits in order to gauge the degree of ripeness/softness. It does this without the need to cut open the fruit. This tool breaks the surface of a fruit with a small hole of about one millimeter in width, so the fruit can continue to ripen if need be.

The invention looks like the body of a simple ball-point pen with a wire probe coming out of the pointed end. The visible part of the wire probe is immersed into the fruit, and if the fruit is hard and not ripe, the spring inside the invention will compress during this immersion and when the body is released, the degree to which the body of the invention springs back, is determined by degree of spring compression and the hardness of the fruit and thereby its ripeness. The harder the inside of the fruit, the more the spring compresses and the more the body of the invention springs back. (See diagrams 2/3 and 3/3)

This hardness/ripeness gauging is achieved in a fairly simple, consistent and measurable manner with the use of a spring inside the body of the invention, which compacts when the wire probe is pushed into hard fruit. An un-ripened hard fruit provides resistance, causing the spring to compress when the probe is pushed inwards. When the body of the invention is released, the compressed spring forces the body of the invention away from the fruit.

In contrast, when the wire probe is pushed into soft/ripe fruit there is little resistance and the spring does not compress, resulting in very little if any spring back when the operator releases the body of the invention. Users will easily get accustomed to how much spring back is personally desired before cutting or biting into the fruit.

The invention consists of a capped tube with a 16 gauge stainless steel food grade wire probe protruding from one end. The remainder of the wire probe is inside the tube along with a spacer and a spring. (See diagram 3/3) The spacer (or filler piece) is needed between the spring and the probe so that they do not intertwine.

To build this invention you need a capped tube, such as the housing for a simple ball-point pen, a spring rated between 2 and 3 pounds per inch that fits inside the pen tube, a spacer that slides easily within the tube and a piece of 16 gauge AWG stainless steel wire to use as the probe. The wire is bent over at the end that butts up to the filler piece which helps position the wire probe and prevents it from falling out of and away from the body of the invention. The length of the wire probe is such that when the wire probe is pushed as far as it can go into the tube, against the spring, approximately half to one inch of the wire probe would be protruding from the narrow end, which enables the operator to push through the hard outer skin of a cantaloupe or melon.

The embodiments of the invention in which an exclusive or privilege is claimed are defined as follows:

1. This Ripe Fruit Indicator consisting of a mechanism which indicates ripeness of a fruit, by gauging how far a spring can move a probe through the flesh of such fruit.
